(19) United States
(12) Patent Application Publication
(10) Pub. No.: US 2005/0175379 A1
(43) Pub. Date: Aug. 11, 2005

(54) Web oiler speed control

(76) Inventors: Richard H. Berg, Greenville, SC (US); Fangsheng Wu, Rochester, NY (US)

Correspondence Address: Mark G. Bocchetti;Patent Legal Staff, Eastman Kodak Company, 343 State Street, Rochester, NY, 14650-2201, US

(21) Appl. No.: 11/021,443

(22) Filed: Dec. 21, 2004

Related U.S. Application Data
(60) Provisional application No. 60/543,014, filed on Feb. 9, 2004.

(51) Int. Cl. G03G 15/20

(52) U.S. Cl. 399/325

(57) ABSTRACT

Maintaining the linear velocity of an oil impregnated web oiler as the oil impregnated web is wound onto a driven take-up roll. When a new oil impregnated web is installed, the take-up roll is initially driven at an angular velocity to yield the predetermined optimum linear velocity of the oil impregnated web. The angular velocity of the take-up roll is decreased according to the algorithm of the invention so as to maintain constant the linear velocity of the oil impregnated web as the oil impregnated web is wound onto the take-up roll.

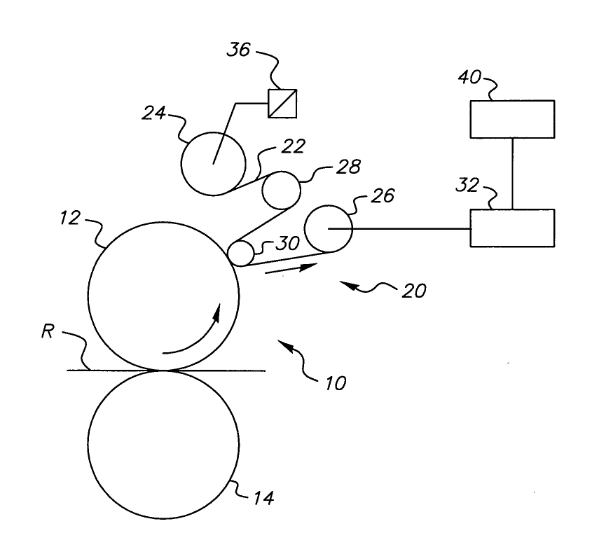

### FIELD OF THE INVENTION

This invention relates in general to release fluid applicators for heated fuser rollers and more particularly to a method of controlling the linear speed of a release fluid, oil impregnated, web oiler.

### BACKGROUND OF THE INVENTION

In electrostatographic reproduction apparatus a latent image charge pattern is formed on a uniformly charged charge-retentive or photoconductive member having dielectric characteristics. Pigmented marking particles are attracted to the latent image charge pattern to develop such image on the photoconductive member. A receiver member, such as a sheet of paper, transparency or other medium, is then brought into contact with the photoconductive member, and an electric field applied to transfer the marking particle developed image to the receiver member from the photoconductive member. After transfer, the receiver member bearing the transferred image is transported away from the photoconductive member, and the image is fixed (fused) to the receiver member by heat and pressure, for example, to form a permanent reproduction thereon.

One type of fuser assembly for typical electrostatographic reproduction apparatus includes at least one heated roller, having an aluminum core and an elastomeric cover layer, and at least one pressure roller in nip relation with the heated roller. The fuser assembly rollers are rotated to transport a receiver member, bearing a marking particle image, through the nip between the rollers. The pigmented marking particles of the transferred image on the surface of the receiver member soften and become tacky in the heat. Under the pressure, the softened tacky marking particles attach to each other and are partially imbibed into the interstices of the fibers at the surface of the receiver member. Accordingly, upon cooling, the marking particle image is permanently fixed to the receiver member.

With roller fuser assemblies, it is common practice to use release fluids, such as silicone oil for example, applied to the fuser roller surface to improve the release of image-carrying receiver members from the fuser roller. The most common types of release fluid applicators or oilers are a rotating wick roller, a donor/metering roller, an oil impregnated pad or roller, an oil impregnated web, or variations or combinations of the above. In a release oil applicator utilizing an oil impregnated web, the web is, for example, formed as a porous membrane capable of retaining release oil. The oil impregnated web extends from a supply roll to a take-up roll. The portion of the oil impregnated web between the supply roll and the take-up roll is directed about intermediate rollers, at least one of which is a back-up roller urging the oil impregnated web into contact with the heated fuser roller. The take-up roller is driven to pull the oil impregnated web from the supply roll onto the take-up roll.

Optimum performance of the heated roller fuser is dependent upon maintenance of the optimum rate of release oil delivery to the heated fuser roller. If the release oil delivery rate falls below the optimum rate, offset of the marking particle developed image from the receiver member to the fuser roller can occur. The offset marking particles will build up on the fuser roller and lead to undesirable image defects and/or premature failure of the fuser roller. If the release oil delivery rate exceeds the optimum rate, excessive release oil will build up on the fuser roller. The excess release oil will be carried away by the receiver member also causing image quality defects and/or release oil contamination of the photoconductive member if the receiver member is returned to the imaging section for transfer of a marking particle image to the opposite side. The release oil delivery rate of an oil impregnated web oiler is directly dependent upon the linear velocity of the oil impregnated web. The release oil delivery rate increases as the linear velocity of the oil impregnated web increases. If the angular velocity of the driven take-up roll is held constant, the linear velocity of the oil impregnated web will increase as the diameter of the oil impregnated web increases due to the oil impregnated web being wound onto the take-up roll.

### SUMMARY OF THE INVENTION

In view of the forgoing discussion, it is the object of the present invention to provide for maintaining the linear velocity of release oil impregnated web oiler as the oil impregnated web is wound onto a driven take-up roll. When a new oil impregnated web is installed, the take-up roll is initially driven at an angular velocity to yield the predetermined optimum linear velocity of the oil impregnated web. The angular velocity of the take-up roll is decreased according to the invention so as to maintain constant the linear velocity of the oil impregnated web as the release oil impregnated web is wound onto the take-up roll.

The invention, and its objects and advantages, will become more apparent in the detailed description of the preferred embodiment presented below.

### BRIEF DESCRIPTION OF THE DRAWINGS

In the detailed description of the preferred embodiments of the invention presented below, reference is made to the accompanying drawings, in which:

The single FIGURE is a schematic side elevational view of an electrostatographic reproduction apparatus fusing assembly, including release oil impregnated web oiler mechanism, the linear velocity of which may be maintained by this invention.

### DETAILED DESCRIPTION OF THE INVENTION

Referring to the FIGURE, there is schematically shown various components of an electrostatographic reproduction apparatus fuser assembly, including release oil impregnated web oiler mechanism, the linear velocity of which may be maintained by this invention. The fuser assembly, designated generally by the numeral 10, has a fusing member 12 in the form of a roller, although a belt, sleeve, or any other variation thereof would be similarly applicable. The fusing member 12 is heated, and is located in nip relation with a pressure roller 14. The fusing nip between the roller of the fusing roller 12 and pressure roller 14 is associated with the receiver member transport path of the reproduction apparatus. That is, as a receiver member bearing a marking particle image travels along the transport path, the marking particle image is fixed to the receiver member by application of heat and pressure in the fusing nip before the receiver member is delivered from the transport path to an output device or a duplex reproduction recirculation path.

The release oil impregnated web oiler mechanism is designated generally by the numeral 20. The oil impregnated web oiler mechanism 20 includes an elongated web 22 extending from a supply roll 24 to a take-up roll 26. The elongated web 22 is, for example, formed as a porous membrane capable of retaining release oil. Illustrative examples of such porous membrane would be micro-porous polytetrafluoroethylene (PTFE) web materials, or non-woven polyester web materials. The elongated web 22 is impregnated with any well known release oil, for example silicone oils with functional groups such as amino or mercaptu groups. That portion of the web 22 between the supply roll 24 and take-up roll 26 is directed about intermediate rollers 28 and 30. The intermediate roller 28 is an idler roller and the intermediate roller 30 is a back-up roller urging the web into intimate contact with the fusing member 12 to apply impregnated release oil from the web to the fusing member surface. The take-up roll 26 is coupled to a drive motor 32 for winding the web onto the take-up roll 26. The supply roll 24 is associated with variable torque device 36 for maintaining constant tension in web 22 as it is fed from the supply roll 24 and wound onto the take-up roll 26. As shown the direction of movement of the web 22 is opposite to the direction of movement of the surface of the fusing member 12 to facilitate release oil lay down on the fusing member surface.

Motor 32 is operatively associated with a logic and control unit 40 to receive appropriate activation signals therefrom to turn on motor 32 for a predetermined period of time at a predetermined speed. The logic and control unit 40 includes, for example, a microprocessor receiving appropriate input signals. Based on such signals and a suitable program for the microprocessor, the unit 40 produces signals to control operation of the reproduction apparatus and carrying out of the reproduction process. The production of the program for a number of commercially available microprocessors is a conventional skill well understood in the art. The particular details of any such program would, of course, depend upon the architecture of the designated microprocessor. The logic and control unit 40 may be located in the main reproduction apparatus logic and control or in the separate logic and control for the fuser assembly 10.

The movement of the web 22 relative to the fuser member 12 ideally affects a controlled lay down of release oil per receiver member. The amount of release oil lay down per receiver member is directly dependent upon the linear velocity of web 22. As discussed above, the lay down of release oil per receiver member should be maintained at a predetermined optimum amount. If the lay down of release oil per receiver member falls below optimum, offset of the marking particle image from the receiver member to the fuser roller 12 can occur. The offset marking particles will build up on the fuser roller 12 and may transfer as undesirable artifacts to subsequent receiver members, and/or may lead to premature failure of the fuser roller 12. If the lay down of release oil per receiver member exceeds the optimum, excessive release oil will build up on the fuser roller 12. The excess release oil may be carried away by the receiver member causing image quality defects and/or release oil contamination of the photoconductive member if the receiver member is returned to the imaging section for transfer of a marking particle image to the opposite side. If motor 32 is run at constant speed, the linear velocity of web 22 will increase due to the increase in diameter of the take-up roll 26 as the web 22 is wound onto the take-up roll 26.

The present invention maintains the release oil lay down per receiver member at the predetermined optimum amount by decreasing the speed of motor 32, from an initial speed with a newly installed web 22, so as to maintain constant the linear velocity of web 22. The core shaft radius, Rᵢ, of take-up roll 26 is equal to the core shaft radius of supply roll 24. The radius of a new fully loaded supply roll is known and will be designated R_{f}. When web 22 is completely used up and wound onto take-up roll 26, the final radius of take-up roll 26 will be R_{f}. The predetermined linear velocity of web 22 to yield the optimum release oil lay down per receiver member will be designated V. The initial speed, designated Sᵢ, of motor 32 with a newly installed web 22 must then be Sᵢ=V/2πRᵢ. The final speed of motor 32, designated S_{f}, when web 22 is completely wound onto take-up roll 26 must then be S_{f}=V/2πR_{f}. The length of web 22, designated L, is known, and therefore the total amount of time to unwind web 22 from supply roll 24 and wind onto take-up roll 26 will be L/V. In the present invention, when a new web 22 is installed, logic and control unit 40 begins driving motor 32 at initial speed Sᵢ and also begins monitoring the elapsed time of rotation of take-up roll 26. The total time, L/V, to unwind web 22 from supply roll 24 and wind onto take-up roll 26 is divided into a predetermined number of increments. Logic and control unit 40 then decrements the speed of motor 32 at the end of each elapsed time increment, by equal amounts so that at the end of total time, L/V, the speed of motor 32 is S_{f}.

In an alternative embodiment of the present invention, each revolution of take-up roll 26 is sensed and the number of accumulated revolutions, n, is used to decrease the speed of motor 32, instead of the elapsed time of rotation. In this embodiment the thickness of release oil impregnated web 22 must be known and will be designated as T. With a newly installed oil impregnated web 22, the initial speed, designated Sᵢ, of motor 32 will again be Sᵢ=V/2πRᵢ, where Ri is the core shaft radius of take-up roll 26. After each revolution of take-up roll 26, logic and control unit 40 decreases the speed of motor 32 to a value equal to Sᵢ(Rᵢ/(Rᵢ+nT)), where n is the number of the revolution of take-up roll 26 just completed. A sensor located in the path of web 22 between supply roll 24 and idler roller 28 senses when web 22 is completely unwound from supply roll 24. When web 22 is completely unwound from supply roll 24, logic and control unit 40 stops the imaging process, allows web 22 to be completely wound onto take-up roll 26, and displays a message to the machine operator that release oil impregnated web 22 must be replaced.

In one embodiment of the present invention a 15 meter long, release oil impregnated web 22 (L=15,000 mm) was wound on a 25 mm diameter (Rᵢ=12.5 mm) core shaft, with a final diameter of 60 mm (R_{f}=30.0 mm). It was determined that a 55.0 mm/min. linear velocity of web 22 yielded a release oil lay down sufficient to prevent offset of marking particles from receiver member to fuser roller and without excess oil build up on the fuser roller. With this web 22 newly installed in web oiler mechanism 20, logic and control unit 40 was programmed to start motor 32 at an initial speed of 0.70 rpm (Sᵢ=V/2πRᵢ=55/25π=0.70 rpm). The total time to unwind web 22 from supply roll 24 and wind onto take-up roll 26 was 273 minutes (15000/55). At the end of this time the final speed of motor 32 was to be 0.30 rpm (S_{f}=V/2πR_{f}=55/60π=0.30 rpm), a total decrease of 0.40 rpm. The total time interval was divided into 100 equal segments, so that logic and control unit 40 was programmed to decrement the speed of motor 32 by 0.004 rpm after each 2.73 minute elapsed time increment. Just over 30,000 prints (at a reproduction apparatus process speed to print approximately 110 prints/min.) were run with varying image content over the total 273 minutes with no image quality deterioration due to offset or failures due to excess release oil lay down.

The invention has been described in detail with particular reference to preferred embodiments thereof, but it should be understood that variations and modifications can be effected within the spirit and scope of the invention.

1. A method of controlling the speed of release oil impregnated web fuser roller oiler comprising the steps of:
a. unwinding said release oil impregnated web from a supply roll into operative contact with a fuser roller;
b. attaching the leading edge of said release oil impregnated web to a take-up roll;
c. rotationally driving said take-up roll at a predetermined initial angular velocity in response to start of rotation of said fuser roller;
d. changing the angular velocity of said take-up roll in a manner in response to the elapsed time of rotation of said take-up roll;
e. sensing when said oil impregnated web is completely unwound from said supply roll; and
f. displaying a message to replace said release oil impregnated web when said release oil impregnated web is completely unwound from said supply roll.

2. The method of claim 1 wherein said decrease in the angular velocity of said take-up roll is selected so as to maintain the linear velocity of said release oil impregnated web constant as said oil impregnated web is wound onto said take-up roll.

3. The method of claim 2 wherein said decrease in angular velocity comprises the steps of:
a. storing in memory a predetermined initial radius (Rᵢ) of said take-up roll;
b. storing in memory a predetermined final radius (R_{f}) of said take-up roll;
c. storing in memory a predetermined length (L) of said release oil impregnated web;
d. storing in memory a predetermined linear velocity V of said release oil impregnated web;
e. start drive of said take-up roll at an angular velocity equal to V/Rᵢ;
f. measuring and storing the elapsed time of rotation of said take-up roll; and
g. after each interval of elapsed time of rotation of said take-up roll equal to a predetermined fraction of the time interval L/V, decrementing the angular velocity of said take-up roll by an amount equal to said predetermined fraction of angular velocity (V/Rᵢ-V/R_{f}).

4. A method of controlling the speed of release oil impregnated web fuser roller oiler comprising the steps of:
a. unwinding said release oil impregnated web from a supply roll into operative contact with a fuser roller;
b. attaching the leading edge of said oil impregnated web to a take-up roll;
c. rotationally driving said take-up roll at a predetermined initial angular velocity in response to start of rotation of said fuser roller;
d. changing the angular velocity of said take-up roll in a predetermined manner in response to the number of revolutions of said take-up roll;
e. sensing when said release oil impregnated web is completely unwound from said supply roll; and
f. displaying a message to replace said release oil impregnated web when said release oil impregnated web is completely unwound from said supply roll.

5. The method of claim 1 wherein said predetermined change decreases the angular velocity of said take-up roll so as to maintain the linear velocity of said release oil impregnated web constant as said release oil impregnated web is wound onto said take-up roll.

6. The method of claim 5 wherein said predetermined change comprises the steps of:
a. storing in memory a predetermined initial radius (Rᵢ) of said take-up roll;
b. storing in memory a predetermined thickness (T) of said oil impregnated web;
c. storing in memory a predetermined linear velocity (V) of said release oil impregnated web;
d. starting drive of said take-up roll at an angular velocity equal to V/Rᵢ;
e. sensing each revolution of said take-up roll and storing the accumulated number (n) of said revolutions; and
f. after each revolution of said take-up roll, decreasing the angular velocity of said take-up roll to a value equal to Sᵢ(Rᵢ/(Rᵢ+nT)).

7. In an electrostatographic reproduction apparatus including a rotatable fuser roller, an assembly for controlling the speed of release oil impregnated web fuser roller oiler comprising:
a release oil impregnated web on a supply roll movable into operative contact with a fuser roller;
a take-up roll to which the leading edge of said release oil impregnated web is attached;
a motor for rotationally driving said take-up roll at a predetermined initial angular velocity in response to start of rotation of said fuser roller;
a control mechanism for changing the angular velocity of said take-up roll in a manner in response to the elapsed time of rotation of said take-up roll, said control mechanism sensing when said oil impregnated web is completely unwound from said supply roll; and
displaying a message to replace said release oil impregnated web when said release oil impregnated web is completely unwound from said supply roll.

8. In an electrostatographic reproduction apparatus including a rotatable fuser roller, an assembly for controlling the speed of release oil impregnated web fuser roller oiler comprising:
a release oil impregnated web on a supply roll moveable into operative contact with a fuser roller;
a take-up roll to which the leading edge of said oil impregnated web is attached;
a motor for driving said take-up roll at a predetermined initial angular velocity in response to start of rotation of said fuser roller;
a control mechanism for changing the angular velocity of said take-up roll in a predetermined manner in response to the number of revolutions of said take-up roll, said control mechanism sensing when said release oil impregnated web is completely unwound from said supply roll; and
displaying a message to replace said release oil impregnated web when said release oil impregnated web is completely unwound from said supply roll.
